(19) United States
(12) Patent Application Publication
(10) Pub. No.: US 2012/0177244 A1
(43) Pub. Date: Jul. 12, 2012

(54) SPEAKER

(75) Inventors: Sha-sha Liu, Shenzhen (CN); Wei Song, Shenzhen (CN)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/325,032

(22) Filed: Dec. 13, 2011

(30) Foreign Application Priority Data
Jan. 7, 2011 (CN) 201120004257.6

(51) Int. Cl. H04R 1/00; F16M 13/00

(52) U.S. Cl. 381/396; 248/342

(57) ABSTRACT

A speaker includes a holder forming a hollow space, a magnetic system received in the hollow space, a suspension assembled with the holder and defining a supporting portion, a pair of fixing portions far away from the supporting portion and fixed on the holder, and a plurality of arm portions connecting the supporting portion and the fixing portions, respectively. The arm portions defines a pair of outer arm portions protruded outwardly from the circumference of two ends of the supporting portion and a pair of inner arm portions extending from the circumference of said two ends of the supporting portion and set in space with respect to the inner arm portions, respectively.

### FIELD OF THE INVENTION

The present disclosure relates to the art of speakers and, particularly to a speaker having a suspension.

### DESCRIPTION OF RELATED ART

Generally, an electronic device, such as a mobile phone, uses a speaker as a sound generator.

A typically speaker includes a holder having a hollow space, a magnetic system received in the hollow space, a diaphragm attached on the holder, a suspension fixed on the holder, and a coil fixed on the suspension and connected with the diaphragm. The suspension defines a supporting portion, a pair of fixing portions far away from the supporting portion for being fixed on the holder, and four arm portions extending the circumference of two ends of the body portion so as to connect the supporting portion to the fixing portions.

In work, the diaphragm can be vibrated approaching and away from the magnetic system in a vibrating direction. However, when the suspension is activated by the coil to vibrate along the vibrating direction repeatedly, a force generated from the coil is mainly applied on the arm portions of the suspension, thereby increasing the distortion or deformation of the arm portion of the suspension.

Therefore, it is desirable to provide a speaker which can overcome the above-mentioned problem.

### BRIEF DESCRIPTION OF THE DRAWINGS

FIG. 1 is an illustrative exploded view of a speaker in accordance with an exemplary embodiment of the present invention;

FIG. 2 is an illustrative assembled view of the speaker;

FIG. 3 is a cross-sectional view of the speaker taken along line III-III in FIG. 2;

FIG. 4 is an isometric view of a yoke of the speaker; and

FIG. 5 is an isometric view of a suspension of the speaker.

### DETAILED DESCRIPTION

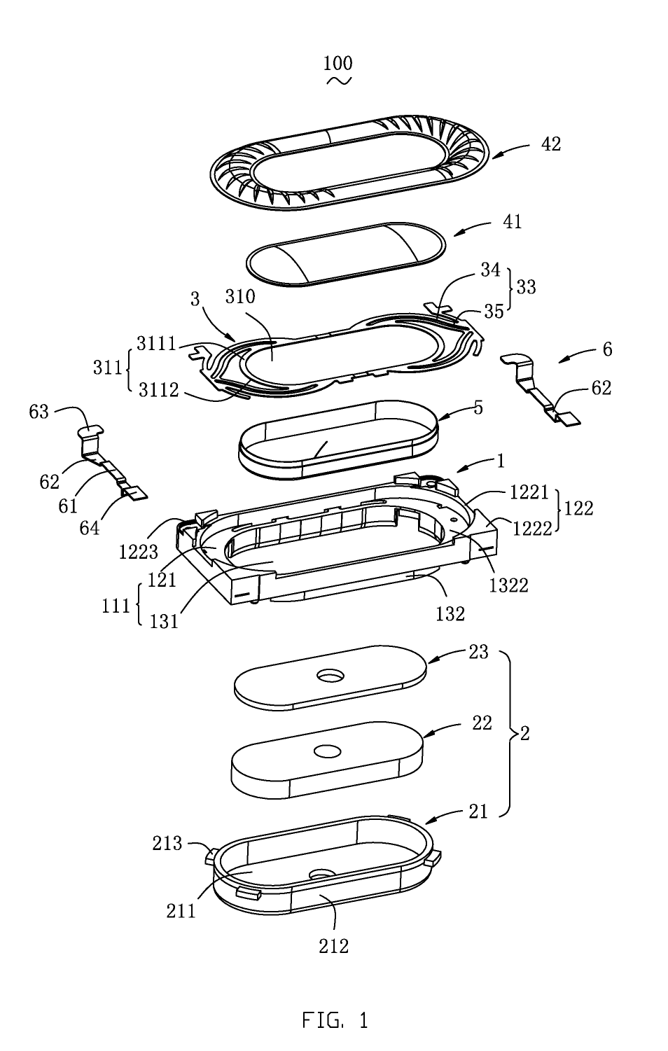

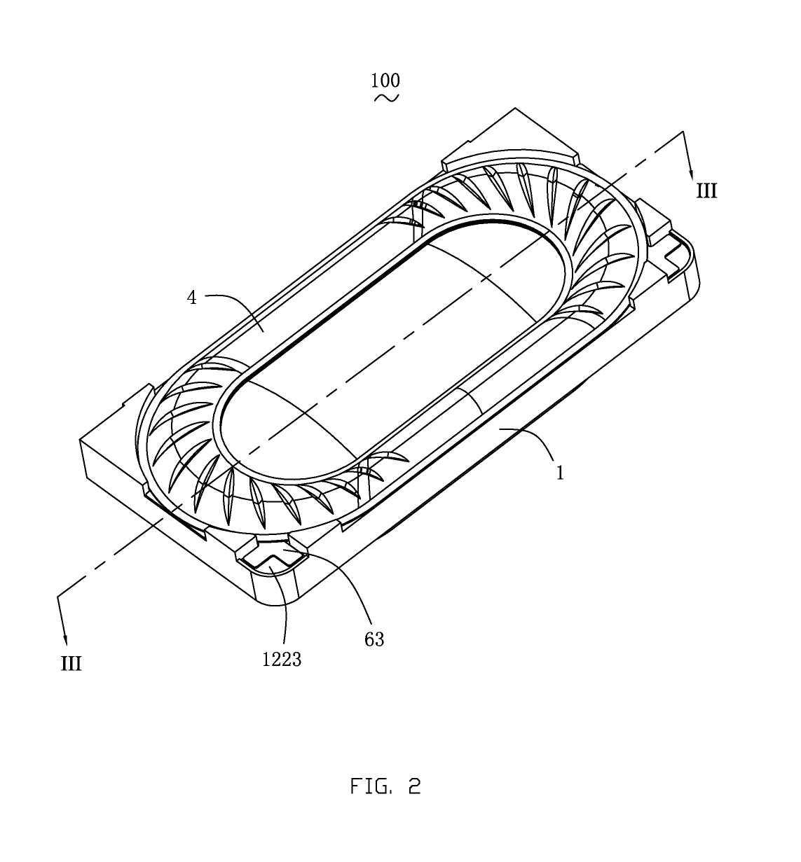

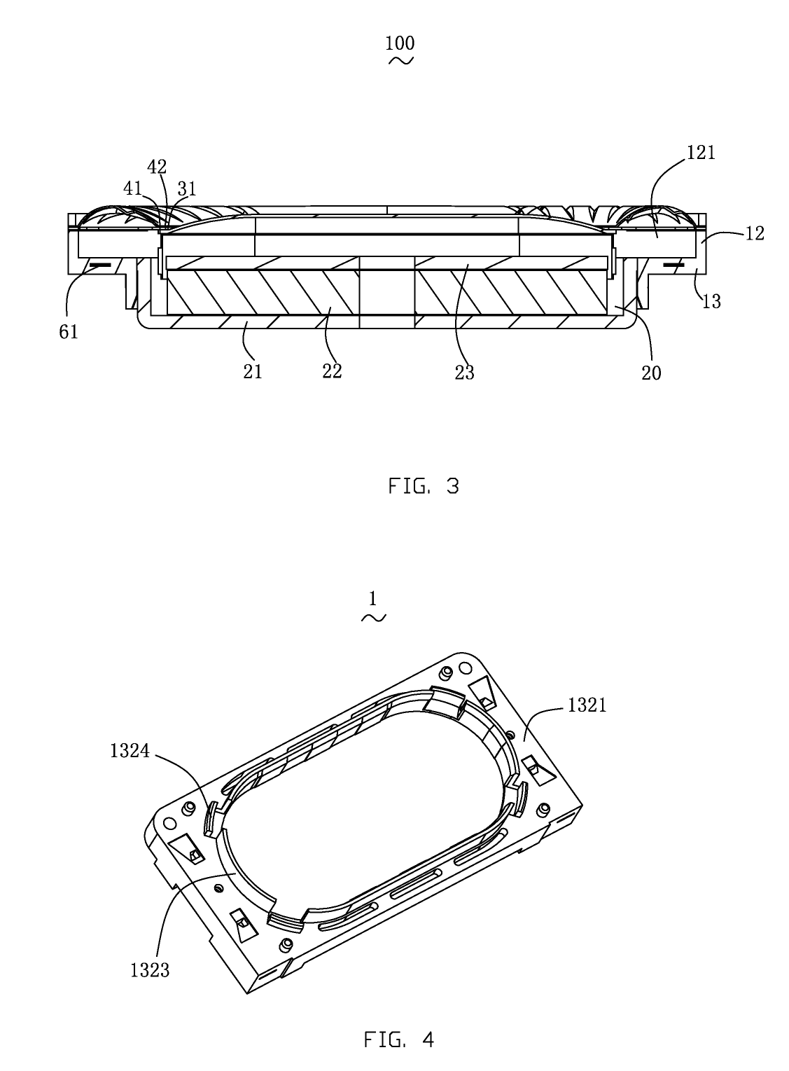

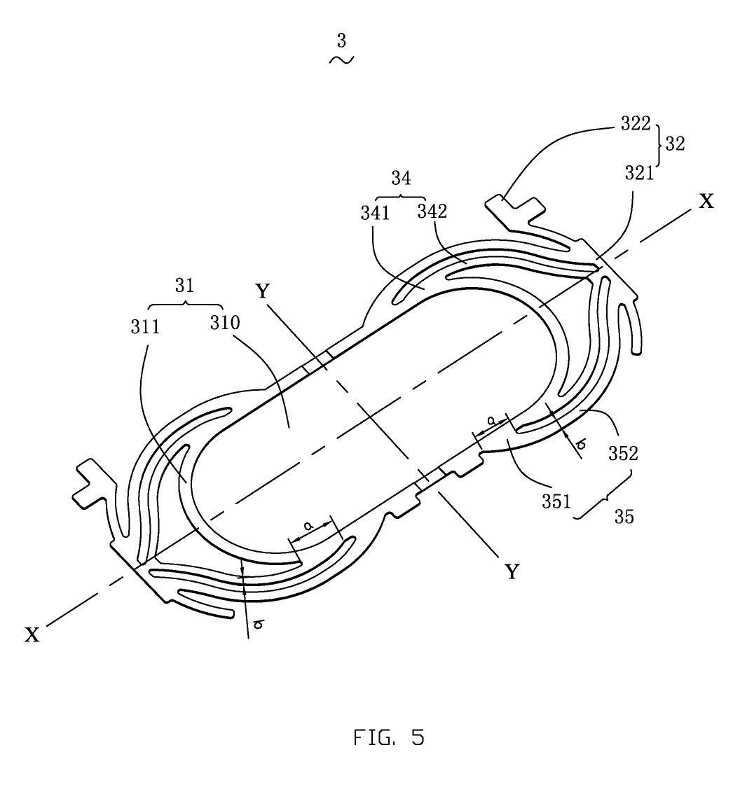

Referring to FIGS. 1-5, a speaker 100, in the exemplary embodiment of the present invention, comprises a holder 1 forming a hollow space 111, a magnetic system 2 received in the hollow space 111 and defining a magnetic gap 20, an suspension 3 assembled with the holder 1, a diaphragm 4 connected with the suspension, a coil 5 defining an end suspended in the magnetic gap 20 and an another end connected with the diaphragm 4, and a pair of terminals 6 assembled with the holder 1 for electrically connecting with the suspension 3.

The suspension 3 defines a minor axis Y-Y and a major axis X-X perpendicular to the minor axis Y-Y. The suspension 3 defines a supporting portion 31, a pair of fixing portions 32 far away from the supporting portion 31 and fixed on the holder 1, and a plurality of arm portions 33 connecting the supporting portion 31 and the fixing portion 32, respectively. The arm portions 33 defines a pair of outer arm portions 34 protruded outwardly from the circumference of two ends of the supporting portion 31 and a pair of inner arm portions 35 extending from the circumference of said two ends of the supporting portion 31 and set in space with respect to the outer arm portions 34, respectively. Each outer arm portions 34 surrounds at least a part of the corresponding inner arm portion 35.

The supporting portion 31 defines an opening 310 and a surrounding portion 311 surrounding the opening 310. The surrounding portion 31, ellipse-shaped, defines an upper surface 3111 and a lower surface 3112 opposite to the upper surface 3111. The surrounding portion defines an upper surface 3111 far away from the magnetic system 2 and a lower surface 3112 opposite to the upper surface 3111.

Each fixing portion 32 of the suspension 3 defines a locating portion 321 for connecting with the arm portions 33 of the suspension 3 and an engaging portion 322 extending from the locating portion 321 for connecting with the terminals 6.

The pair of outer arm portions 34 is symmetrical with respect to a minor axis Y-Y of the suspension 3. The pair of inner arm portions 35 is also symmetrical with respect to a minor axis Y-Y of the suspension 3. Each outer and inner arm portions 34, 35 defines a connecting portion 341, 351 smoothly connected with the supporting portion 311 and an extending portion 342, 352 extending from the connecting portion 341, 351 for connecting with the corresponding fixing portion 32, respectively. A width a of the connecting portion 341, 351 is greater than that of the extending portion 342, 352, so as to prevent the suspension from deformating. The width b of the extending portion 342, 352 remains constant over a length of the extending portion 342, 352.

The diaphragm 4 defines a dome part 41 connected with the lower surface 3112 of the suspension 3 and an edge part 42 connected with the upper surface 3111 of the suspension 3. The coil 5 connects with the dome part 41 of the diaphragm 4, so as to provide a driving force onto the diaphragm 4 rapidly.

The magnetic system 2 defines a yoke 21, a magnet 22, and a pole plate 23 attached onto a top surface of the magnet 22. The yoke 21 defines a bottom wall 211, a plurality of sidewalls 212 extending upwardly from the periphery of the bottom wall 211, and four engaging flanges 213 extending from the sidewalls 212 and away from the yoke 2.

The holder 1 defines a base portion 12 and a body portion 13 connected with the base portion 12. The hollow space 111 defines a first hollow space 121 formed on the base portion 12 for receiving the suspension 3, the diaphragm 4 and a part of the coil 5 and a second hollow space 131 formed on the body portion 13 for receiving the magnetic system 2 and another part of the coil 5. The base portion 12 further defines a mounting portion 122 surrounding the first hollow space 121. The body portion 13 further defines a holding portion 132 surrounding the second hollow space 131. The first hollow space 121 is communicated with the second hollow space 131. A diameter of the first hollow space 121 is greater than that of the second hollow space 131, so as to provide a vibrating space (no labeled) for the suspension 3, the diaphragm 4 and a part of the coil 5.

The mounting portion 122 defines a mounting surface 1221 far away from the body portion 13 and four corner portions 1222 extending from the mounting surface 1221 away from the body portion 13. At least two corner portions 1222 define a receiving hole 1223 for receiving the engaging portion 322 of the fixing portion 32. One corner portion cooperates with corresponding corner portion for fixing the locating portion 321 of the fixing portion 32 on the holder 1 firmly.

The holding portion 132 of the body portion 13 defines a first holding surface 1321 far away from the suspension 3, a second holding surface 1322 opposite to the first holding surface 1321, and four holding walls 1323 extending from the seconding holding surface 1322 towards the first holding surface 1321 and away from the first holding surface 1321. Each holding wall 13213 is unconnected with adjacent holding walls. Two adjacent holding walls 1323 are engaged with the corresponding engaging flange 213 of the yoke 2, so as to fix the yoke 2 on the holding portion 132. The holding portion 132 further defines four engaging wall 1324 set space with respect to the holding walls 1323 and engaging with the corresponding engaging flange 213 of the yoke 2, so as to fix the yoke 2 on the holding portion 132 firmly. In assembled, the engaging flanges 213 of the yoke 2 are provided on the first holding surface 1321 of the holding portion 132 and do not provided on the vibrating space, so as to reduce a vibrating space of the speaker 100.

Each terminal 6 defines a holding portion 61 receiving in the holder 1, a pair of soldering portion 62 extending downwardly from the two ends of the holding portion 61 and exposed out of the first holding surface 1321 of the holder 1, a contacting portion 63 extending upwardly from one soldering portion 62 for connecting with the engaging portion 322 of the fixing portion 32 of the suspension 3, and an ending portion 64 extending upwardly from another soldering portion 62.

The outer and inner arm portions of the suspension effectively absorb a force applied by the coil and even the force, so that the suspension is not subjected to deformation easily.

It will be understood that the above particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A speaker comprising:
a holder forming a hollow space;
a magnetic system received in the hollow space;
a suspension assembled with the holder and defining a supporting portion, a pair of fixing portions far away from the supporting portion and fixed on the holder, and a plurality of arm portions connecting the supporting portion and the fixing portions, the arm portions defining a pair of outer arm portions protruded outwardly from the circumference of two ends of the supporting portion and a pair of inner arm portions extending from the circumference of said two ends of the supporting portion; wherein
each outer arm portion surrounds at least a part of the corresponding inner arm portion and set in space with respect to the inner arm portion.

2. The speaker as claimed in claim 1, wherein the pair of outer arm portions is symmetrical with respect to a minor axis of the suspension.

3. The speaker as claimed in claim 1, wherein each arm portion defines a connecting portion connecting with the supporting portion and an extending portion extending from the connecting portion for connecting with the corresponding fixing portion and a width of the connecting portion is greater than that of the extending portion.

4. The speaker as claimed in claim 3, wherein the width of the extending portion remains constant over a length of the extending portion.

5. The speaker as claimed in claim 1, wherein the suspension defines an upper surface far away from the magnetic system and a lower surface opposite to the upper surface and the diaphragm defines an edge part connected with the upper surface of the suspension and a dome part connected with the lower surface of the suspension.

6. The speaker as claimed in claim 1, wherein the holder defines a first holding surface and the magnetic system defines a yoke having a plurality of engaging flanges engaging with the first holding surface.

7. The speaker as claimed in claim 6, wherein the holder further defines a plurality of holding wall extending from the first holding surface away from the holder for engaging with the engaging flanges of the yoke.

8. The speaker as claimed in claim 6, wherein the speaker further defines a pair of terminals and each terminal defines a holding portion receiving into the holder, a soldering portion extending downwardly from the holding portion and exposed out of the first holding surface of the holder, and a contacting portion extending upwardly from one soldering portion for connecting with the fixing portion of the suspension.

9. The speaker as claimed in claim 8, wherein the holder defines a mounting surface for mounting the suspension and a plurality of corner portions extending from the mounting surface for fixing the suspension on the holder firmly.

10. The speaker as claimed in claim 9, wherein each fixing portion of the suspension defines an engaging portion connected with the contacting portion of each terminal and at least two corner portions of the holder define a pair of receiving holes for receiving the engaging portion of each fixing portion and the contacting portion of each terminal.

11. A suspension comprising:
a supporting portion;
a pair of fixing portions far away from the supporting portion; and
eight arm portions connecting the supporting portion and the fixing portions, respectively; wherein
the arm portions defining four outer arm portions protruded outwardly from the circumference of two ends of the supporting portion and four inner arm portions extending from the circumference of said two ends of the supporting portion and set space with respect to the outer arm portions; and wherein
two outer arm portions protrude outwardly from one end of the supporting portion surrounding two inner arm portions extending from said one end of the supporting portion, and two outer arm portions protrude outwardly from another end of the supporting portion surrounding two inner arm portions extending from said another end of the supporting portion.

12. The suspension as claimed in claim 11, wherein each arm portion defines a connecting portion connecting with the supporting portion and a extending portion extending from the connecting portion for connecting with the corresponding fixing portion, and a width of the connecting portion is greater than that of the extending portion.

13. The suspension as claimed in claim 12, wherein the width of the extending portion remains constant over a length of the extending portion.
